(19) United States
(12) Patent Application Publication
(10) Pub. No.: US 2012/0201035 A1
(43) Pub. Date: Aug. 9, 2012

(54) DIMMER FOR LIGHT SOURCES

(75) Inventor: Roberto Gutierrez, El Paso, TX (US)

(73) Assignee: Inicia IP Holdings, LLC.

(21) Appl. No.: 13/353,526

(22) Filed: Jan. 19, 2012

Related U.S. Application Data
(60) Provisional application No. 61/440,020, filed on Feb. 7, 2011.

(51) Int. Cl. F21V 1/00; H01H 11/00

(52) U.S. Cl. 362/351; 29/622

(57) ABSTRACT

A dimmer for a light source includes two sheets of polarized films stacked together. The first film is fixed to the lamp shade so as to create a barrier for the light being emitted from the lamp. The second film is mounted to a movable outer ring over the first such as to allow for free rotation with respect to the first film. The amount of light that is allowed to escape from the lamp is modulated by rotating the outer ring, which causes the polarization angle of the movable film to change with respect to the fixed film.

### CROSS-REFERENCE TO PROVISIONAL APPLICATION

This patent application claims the benefit under 35 U.S.C. §119(e) of U.S. Provisional Application Ser. No. 61/440,020 entitled, “Dimmer for Light Sources,” which was filed on Feb. 7, 2011 and is incorporated herein by reference in its entirety.

### TECHNICAL FIELD

Embodiments are generally related to dimmers for light sources. Embodiments also relate to the field of dimmers for light-emitting diodes (LEDs) and fluorescent light bulbs for example compact fluorescent lights (CFLs). Embodiments additionally relate to a dimmer arrangement comprising two polarized films that can be rearranged rotationally to create different levels of light interference.

### BACKGROUND OF THE INVENTION

For home interior applications there are three basic types of light bulb technologies such as incandescent light bulbs including halogens, fluorescent light bulbs including the squiggly Compact Fluorescent Lights (CFL), or CFLs, and light-emitting diodes (LEDs). Halogen lamps have tremendous popularity in the past decades, especially in the form of desktop lamps or standing “torchiere” lamps, for their ability to put out a large amount of light. There are, however, some problems with the halogen light bulbs. First, its durability is a fraction of comparable LED or CFL lights. Second, they consume an inordinate amount of electricity typically 150 W as compared to 9 W for an LED or 25 W for a CFL. Third, because they are so inefficient, they convert most of electrical energy into heat, which creates a huge fire hazard. Due to this reason several university campuses have actually banned halogen lamps from dorm rooms. Yet halogen lamps and all incandescent lamps in general have the ability to dim the light that was not possible neither with CFLs or LEDs.

FIG. 1 illustrates a typical torchiere-type halogen lamp 100 which consists of a base 125 with a tall, often tubular support 120 for the light socket, and a metallic shade 110 turned upside down so as to shield the halogen light bulb 105 from access from underneath and project the light towards the ceiling. The On/Off knob 115 is typically a rheostat-type current controlling device that allows the lamp 100 to be turned on, dimmed, or turned off. The rheostat-type dimming devices for dimming the light output can only be utilized with incandescent light bulbs and the same is not possible with CFLs or LEDs lamps.

One prior art include an LED ballast circuit for dimming one or more LEDs using a phase controlled dimmer switch. The LED ballast circuit has a power conditioning unit which includes a substantially fixed duty cycle clock for outputting a clock cycle and a transformer configured to store energy and discharge a substantial portion of the stored energy once per clock cycle in order to power one or more LEDs. The LED ballast circuit and load collectively behave like a resistor.

Another prior art discloses an Compact Fluorescent Lamp (CFL) in which the level of illumination is controlled by a triac dimmer. Premature turn off of the triac dimmer is avoided through the serial combination of at least one resistor and at least one capacitor forming a snubber placed across the output of the electromagnetic interference filter of the CFL ballast. The snubber dampens oscillations generated within the compact fluorescent lamp whereby sufficient power is drawn by the CFL to sustain conduction of the triac dimmer throughout the dimming range of the latter.

The prior art dimmer circuits are complex and controls the amount of power furnished to the light bulb. As the CFLs or LEDs lamps are durable, consume less power and efficient, different lighting moods can be easily obtained by adjusting the amount of the output light from CFLs or LEDs itself. As the CFLs or LEDs lamps cannot be dimmed via a rheostat, there exists a simple dimmer arrangement that can be used in any application where the desired amount of light transmission has to be changed.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide dimmers for light sources.

It is another aspect of the disclosed embodiments to provide dimmers for Light Emitting Diodes (LEDs) and Compact Fluorescent Lights(CFLs).

It is a further aspect of the present invention to provide a dimmer arrangement comprising two polarized films that can be rearranged rotationally to create different levels of light interference.

The aforementioned aspects and other objectives and advantages can now be achieved as described herein. A dimmer for a light source includes two sheets of polarized films stacked together. The first film is fixed to the lamp shade so as to create a barrier for the light being emitted from the lamp. The second film is mounted to a movable outer ring over the first and allows free rotation with respect to the first film. The amount of light that is allowed to escape from the lamp is modulated by rotating the outer ring, which causes the polarization angle of the movable film to change with respect to the fixed film.

Different lighting moods such as “Fully On”, “Half Dim” and “Fully Dimmed” can be obtained by rotating the outer ring. A ring locator tab attached to the outer ring can be utilized for rotating the outer ring. Rotation of outer ring changes the polarization angle of second film with respect to the fixed first film.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a perspective view of a prior art torchiere-type halogen lamp;

FIG. 2A illustrates a perspective view of a lamp with a dimmer, in accordance with the disclosed embodiments;

FIG. 2B illustrates an exploded view of the lamp with a dimmer depicted in FIG. 2A, in accordance with the disclosed embodiments;

FIG. 3A illustrates an arrangement of two polarized films having aligned polarization angles, in accordance with the disclosed embodiments;

FIG. 3B illustrates an arrangement of two polarized films having misaligned polarization angles, in accordance with the disclosed embodiments;

FIG. 4A illustrates a perspective view of the dimmer of the lamp depicted in FIG. 2A showing the arrangement of two polarized films in “Fully On” position, in accordance with the disclosed embodiments;

FIG. 4B illustrates a perspective view of the dimmer of the lamp depicted in FIG. 2A showing the arrangement of two polarized films in “Half Dim” position, in accordance with the disclosed embodiments;

FIG. 4C illustrates a perspective view of the dimmer of the lamp depicted in FIG. 2A showing the arrangement of two polarized films in “Fully Dimmed” position, in accordance with the disclosed embodiments; and

FIG. 5 illustrates a flow chart depicting the process of arranging the dimmer depicted in FIG. 2A to obtain required lighting moods, in accordance with the disclosed embodiments.

### DETAILED DESCRIPTION

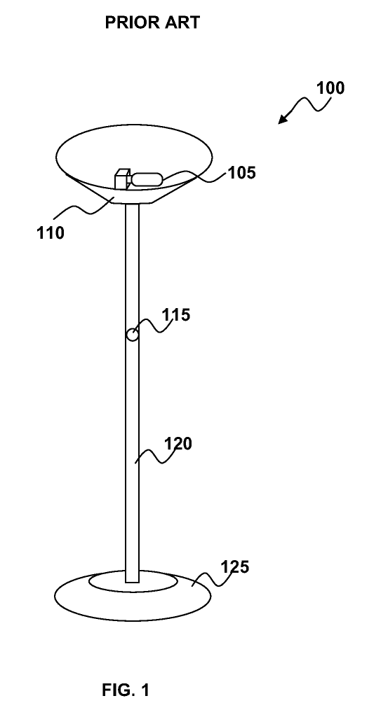

The particular values and configurations discussed in these non-limiting examples can be varied and are cited merely to illustrate at least one embodiment and are not intended to limit the scope thereof. Note that in FIGS. 1-3, identical or similar parts or elements are generally indicated by identical reference numerals.

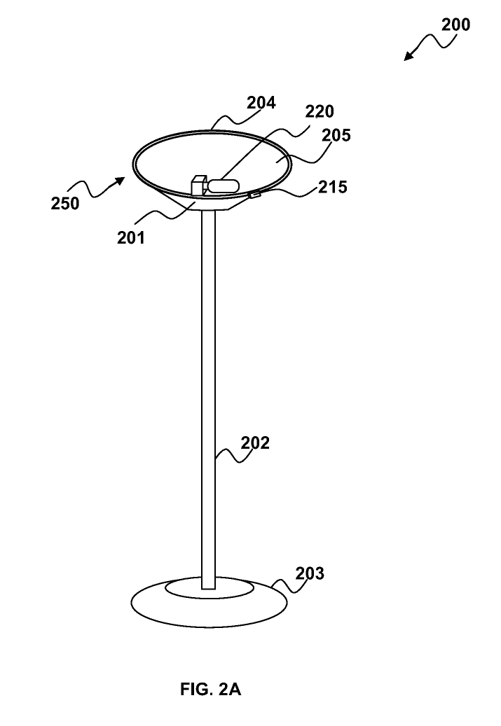

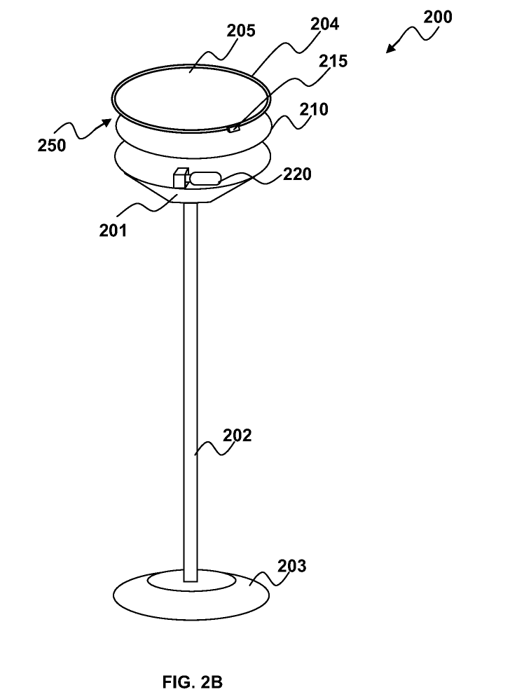

FIG. 2A illustrates a perspective view of a lamp 200 with a dimmer 250, in accordance with the disclosed embodiments. The lamp 200 can be Light Emitting Diodes (LEDs) or Compact Fluorescent Lights (CFLs) lamp. The lamp 200 comprises of a dimmer 250, a base 203, a tubular support 202, a LED or CFL bulb 220 and a metallic shade 201. The dimmer 250 comprises of a first film (not shown) and a second film 205, an outer ring 204 and a ring locator tab 215.

FIG. 2B illustrates an exploded view of the dimmer 250 of the lamp 200 depicted in FIG. 2A, in accordance with the disclosed embodiments. The first film 210 and the second film 205 are stacked together. The first film 210 is fixed to the lamp shade 201 so as to create a barrier for the light being emitted from the lamp 200. The second film 205 is mounted to a movable outer ring 204 over the first film 210 and allows free rotation with respect to the first film 210. The amount of light that is allowed to escape from the lamp 200 is modulated by rotating the outer ring 204, which causes the polarization angle of the movable second film 205 to change with respect to the fixed first film 210. The ring locator tab 215 attached to the outer ring 204 can be utilized for rotating the outer ring 204. The first film 210 and second film 205 can also be referred together as two polarized films 210 and 205 or individually as fixed film 210 and movable film 205.

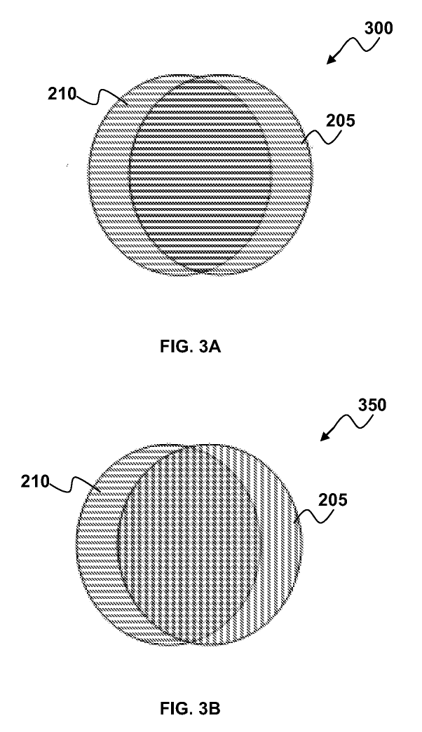

FIG. 3A illustrates an arrangement 300 of two polarized films 210 and 205 having aligned polarization angles, in accordance with the disclosed embodiments. Fully aligned polarization angles of films 210 and 205 allow maximum transfer of light from LED or CFL 220. FIG. 3B illustrates an arrangement 350 of two polarized films having misaligned polarization angles, in accordance with the disclosed embodiments. Fully misaligned or partially misaligned polarization angles of films 210 and 205 allow minimum or partial transfer of light from LED or CFL 220 respectively. Even though the light bulb 220 also referred as LED or CFL 220 inside the lamp 200 remains on at a constant brightness, the light being allowed to escape out of the lamp 200 is modulated to create different lighting moods. The different lighting moods presently illustrated are “Fully On”, “Half Dim” and “Fully Dimmed” moods, but it should be understood that lighting moods (or the amount of light transmission) can be infinitely varied between the two extremes “Fully On” and “Fully Dimmed”.

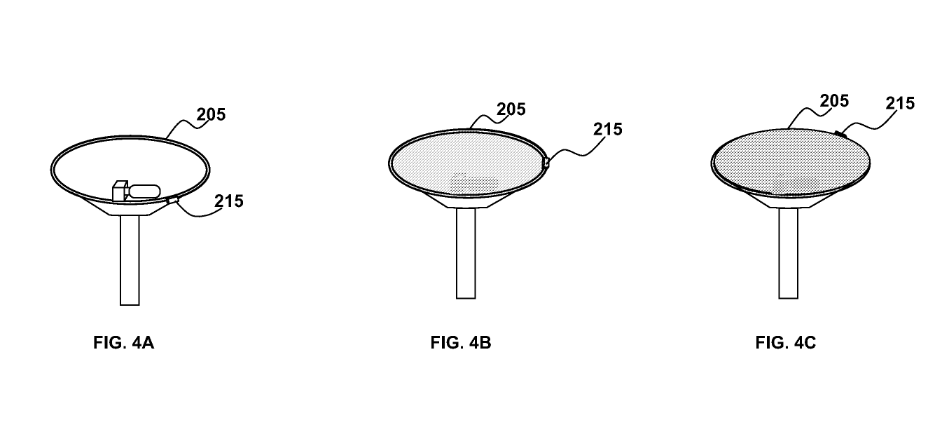

FIG. 4A illustrates a perspective view of the dimmer 250 of the lamp 200 depicted in FIG. 2A showing the arrangement of two polarized films 205 and 210 in “Fully On” position, in accordance with the disclosed embodiments. In “Fully On” position, the polarization angle of the second film 210 is adjusted using the ring locator tab 215 such that the polarization angles of the films 205 and 210 are fully aligned and allows maximum transmission of light emitted from LED or CFL 220. FIG. 4B illustrates a perspective view of the dimmer 250 of the lamp 200 depicted in FIG. 2A showing the arrangement of two polarized films 205 and 210 in “Half Dim” position, in accordance with the disclosed embodiments. In “Half Dim” position, the polarization angle of the second film 210 is adjusted using the ring locator tab 215 such that the polarization angles of the films 205 and 210 are half misaligned and allows partial transmission of light emitted from LED or CFL 220.

FIG. 4C illustrates a perspective view of the dimmer 250 of the lamp 200 depicted in FIG. 2A showing the arrangement of two polarized films 205 and 210 in “Fully Dimmed” position, in accordance with the disclosed embodiments. In “Fully Dimmed” position, the polarization angle of the second film 210 is adjusted using the ring locator tab 215 such that the polarization angles the films 205 and 210 are fully misaligned and allows minimum transmission of light emitted from LED or CFL 220.

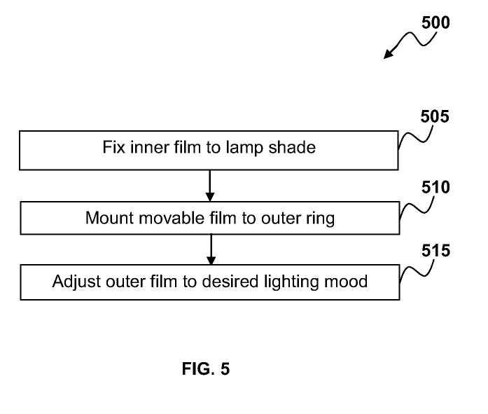

FIG. 5 illustrates a flow chart depicting the process of arranging the dimmer 250 depicted in FIG. 2A to obtain required lighting moods, in accordance with the disclosed embodiments. The first film is fixed to the lamp shade as illustrated at block 505. Then, the second film is rotatably mounted over the first film as depicted at block 510. The polarization angle of second movable film is changed and the required lighting mood can be obtained by adjusting the ring locator tab as illustrated at block 515.

The present invention may be integral to the lamp design, or it may be an after-market accessory which may be used with the existing lamps. Also, the exact design, functionality, and method of execution can vary from what is illustrated here. However, the arrangement of two polarized films in the present invention or similar arrangements could be used in any application where the desired amount of light transmission may change from one moment to the other and a means of controlling it is desired. Such applications may include, but are not limited to industrial lighting applications, automotive or residential window shading, outdoor equipment such as awnings, camping tents, parasols, umbrellas, etc.

Based on the foregoing, it can be appreciated that a number of embodiments are disclosed. For example, in one embodiment, a dimmer apparatus for a light source, can be provided, which includes a first film fixed to a shade of the light source; a second film mounted to a rotatable outer ring; and a ring locator tab attached to the outer ring for modulating amount of light from the light source. In another embodiment, modulation of the ring locator tab can alter the polarization angle of the second film with respect to the first film.

In yet another embodiment, the light source can be at least one light emitting diode. In still another embodiment, the light source can be at least one fluorescent light. In still other embodiments, the at least one fluorescent light can be a CFL (Compact Fluorescent Light). In yet another embodiment, the ring locator tab can adjust the polarization angle of the second film fully aligned with respect to the first film. In other embodiments, the ring locator tab can adjust the polarization angle of the second film half misaligned with respect to the first film. In yet other embodiments, the ring locator tab can adjust the polarization angle of the second film fully misaligned with respect to the first film. In still other embodiments, the change in the polarization angle of the second film with respect to the first film can alter as the amount of light emitted from the light source.

In still another embodiment, a dimmer apparatus for a light source can include, for example, a first film fixed to a shade of the light source; a second film mounted to a rotatable outer ring; and a ring locator tab attached to the outer ring for modulating amount of light from the light source, wherein a modulation of the ring locator tab changes polarization angle of the second film with respect to the first film.

In yet another embodiment, a method of configuring a dimmer for a light source, can be implemented. Such a method can include, for example, affixing a first film to a shade of the light source; mounting a second film to a rotatable outer ring; and attaching a ring locator tab to the outer ring for modulating amount of light from the light source.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A dimmer apparatus for a light source, said apparatus comprising:
a first film fixed to a shade of said light source;
a second film mounted to a rotatable outer ring; and
a ring locator tab attached to said outer ring for modulating amount of light from said light source.

2. The apparatus of claim 1 wherein a modulation of said ring locator tab changes a polarization angle of said second film with respect to said first film.

3. The apparatus of claim 1 wherein said light source comprises at least one light emitting diode.

4. The apparatus of claim 1 wherein said light source comprises at least one fluorescent light.

5. The apparatus of claim 4 wherein said at least one fluorescent light comprises a CFL (Compact Fluorescent Light).

6. The apparatus of claim 1 wherein said ring locator tab adjusts a polarization angle of said second film fully aligned with respect to said first film.

7. The apparatus of claim 1 wherein said ring locator tab adjusts a polarization angle of said second film half misaligned with respect to said first film.

8. The apparatus of claim 1 wherein said ring locator tab adjusts a polarization angle of said second film fully misaligned with respect to said first film.

9. The apparatus of claim 1 wherein a change in polarization angle of said second film with respect to said first film alters an amount of light emitted from said light source.

10. A dimmer apparatus for a light source, said apparatus comprising:
a first film fixed to a shade of said light source;
a second film mounted to a rotatable outer ring; and
a ring locator tab attached to said outer ring for modulating amount of light from said light source, wherein a modulation of said ring locator tab changes polarization angle of said second film with respect to said first film.

11. The apparatus of claim 10 wherein said light source comprises at least one fluorescent light.

12. The apparatus of claim 10 wherein said ring locator tab adjusts a polarization angle of said second film fully aligned with respect to said first film.

13. The apparatus of claim 10 wherein said ring locator tab adjusts a polarization angle of said second film half misaligned with respect to said first film.

14. The apparatus of claim 10 wherein said ring locator tab adjusts a polarization angle of said second film fully misaligned with respect to said first film.

15. The apparatus of claim 10 wherein a change in a polarization angle of said second film with respect to said first film changes an amount of light emitted from said light source.

16. The apparatus of claim 10 wherein said light source comprises at least one light emitting diode.

17. A method of configuring a dimmer for a light source, said method comprising:
affixing a first film to a shade of said light source;
mounting a second film to a rotatable outer ring; and
attaching a ring locator tab to said outer ring for modulating amount of light from said light source.

18. The method of claim 17 further comprising modulating said ring locator tab to alter a polarization angle of said second film with respect to said first film.

19. The method of claim 17 wherein said light source comprises at least one light emitting diode.

20. The method of claim 17 wherein said light source comprises at least one fluorescent light.
